(19) United States
(12) Patent Application Publication
(10) Pub. No.: US 2015/0249829 A1
(43) Pub. Date: Sep. 3, 2015

(54) Method, Apparatus and Computer Program Product for Video Compression

(71) Applicant: LIBRE COMMUNICATIONS INC., Vancouver (CA)

(72) Inventors: Peter Koat, Surrey (CA); Philip Nerland, Vancouver (CA)

(21) Appl. No.: 14/428,813

(22) PCT Filed: Sep. 17, 2012
(86) PCT No.: PCT/CA2012/050643

§ 371 Date: Mar. 17, 2015

Related U.S. Application Data
(60) Provisional application No. 61/535,199, filed on Sep. 15, 2011.

(51) Int. Cl. H04N 19/124; H04N 19/61; H04N 19/117; H04N 19/172; H04N 19/159

(52) U.S. Cl. CPC H04N 19/124; H04N 19/172; H04N 19/159; H04N 19/117; H04N 19/61

(57) ABSTRACT

The present invention provides a method, apparatus and computer program product for video compression. The technology includes features wherein video content is initially obtained and subsequently separated into picture content and audio content. The picture content is separated into a frame by frame configuration, and a frame type for compression is determined for each of these frames. A frame is filtered and segmented into two or more portions, wherein each portion is indicative of a desired quantization for use during the encoding process. Each portion of the frame is subsequently encoded according to the respective desired quantization. Encoded picture content is generated and includes each encoded portion of a frame and its respective desired quantization. This encoded picture content is interleaved with the encoded audio content, thereby resulting in the compression of the video content. Upon reversal of this sequence of tasks will enable the substantial recreation of the video content for subsequent presentation.

### FIELD OF THE INVENTION

The present invention pertains to the field of video signal processing and in particular to video compression.

### BACKGROUND

As a method for digitalizing, recording and transmitting a large amount of video information, encoding formats such as Moving Picture Experts Group (MPEG) have been established. For example, MPEG-1 format, MPEG-2 format, MPEG-4 format H.264/Advanced Video Coding (AVC) format and the like have been established as international standard encoding formats. These formats are used for digital satellite broadcasting, digital versatile discs (DVD), mobile phones, digital cameras and the like as encoding formats. The range of use of the formats has been expanded, and the formats are more commonly used.

According to the formats, an image to be encoded is predicted on a block basis using information on an encoded image, and the difference (prediction difference) between an original image and the predicted image is encoded. In the formats, by removing redundancy of video, the amount of coded bits is reduced. Especially, in inter-prediction in which an image that is different from an image to be encoded is referenced, a block that highly correlates with a block to be encoded is detected from the referenced image. Thus, the prediction is performed with high accuracy. In this case, however, it is necessary to encode the prediction difference and the result of detecting the block as a motion vector. Thus, an overhead may affect the amount of coded bits.

There are generally three different encoding formats which may be applied to video data. Intra-frame coding produces an “I” block, designating a block of data where the encoding relies solely on information within a video frame where the macroblock of data is located. Inter-frame coding may produce either a “P” block or a “B” block. A “P” block designates a block of data where the encoding relies on a prediction based upon blocks of information found in a prior video frame. A “B” block is a block of data where the encoding relies on a prediction based upon blocks of data from surrounding video frames, i.e., a prior I or P frame and/or a subsequent P frame of video data.

In H.264/AVC format, a technique for predicting the motion vector is used in order to reduce the amount of coded bits for the motion vector. That is, in order to encode the motion vector, the motion vector of a block to be encoded is predicted using an encoded block that is located near the block to be encoded. Variable length coding is performed on the difference (differential motion vector) between the predictive motion vector and the motion vector.

However, there remains a need for a video compression/decompression method and corresponding apparatus which can provide a further improvement compression ratio while providing a desired video quality upon decompression.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method, apparatus and computer program product for video compression. In accordance with an aspect of the present invention, there is provided method for compressing video, said method comprising: obtaining video content; separating the video content into picture content and audio content; dividing the picture content into a frame by frame configuration; determining frame type for compression of one or more frames of the frame by frame configuration; filtering one or more frames, said filtering enabling segmentation of the frame into two or more portions, each portion indicative of a desired quantization; encoding each portion of the frame, wherein each portion is encoded based on a respective desired quantization; generating encoded picture content which includes each encoded portion of the frame and its respective desired quantization; and interleaving the encoded picture content with encoded audio content resulting in compression of the video content.

In accordance with another aspect of the present invention, there is provided an apparatus for compressing video, said apparatus comprising: a separator configured to obtain video content and separate the video content into picture content and audio content; a picture frame divider configure to divide the picture content into a frame by frame configuration; a frame type evaluator configured to determine frame type for compression of one or more frames of the frame by frame configuration; a frame filter and encoder configured to filter one or more frames, said filtering enabling segmentation of the frame into two or more portions, each portion indicative of a desired quantization, the frame filter and encoder further configured to encode each portion of the frame, wherein each portion is encoded based on a respective desired quantization and generate encoded picture content which includes each encoded portion of the frame and its respective desired quantization; an audio encoder configured to encode the audio content; and an interleaver/multiplexer configured to interleave the encoded picture content with encoded audio content resulting in compression of the video content.

In accordance with another aspect of the present invention, there is provided a computer program product comprising code which, when loaded into memory and executed on a processor of a computing device, is adapted to compress video content, the code adapted to perform: obtaining video content; separating the video content into picture content and audio content; dividing the picture content into a frame by frame configuration; determining frame type for compression of one or more frames of the frame by frame configuration; filtering one or more frames, said filtering enabling segmentation of the frame into two or more portions, each portion indicative of a desired quantization; encoding each portion of the frame, wherein each portion is encoded based on a respective desired quantization; generating encoded picture content which includes each encoded portion of the frame and its respective desired quantization; and interleaving the encoded picture content with encoded audio content resulting in compression of the video content.

### BRIEF DESCRIPTION OF THE FIGURES

FIG. 1 illustrates a flow diagram of a method for video compression according to embodiments of the present invention.

FIG. 2 illustrates a schematic of an encoder in accordance with embodiments of the present invention.

FIG. 3 illustrates a schematic of an encoder system in accordance with embodiments of the present invention.

FIG. 4 illustrates a schematic of frame referencing scheme in accordance with embodiments of the present invention.

FIG. 5 illustrates a schematic of frame referencing scheme in accordance with embodiments of the present invention.

FIG. 6 illustrates a schematic of frame referencing scheme in accordance with embodiments of the present invention.

### DETAILED DESCRIPTION OF THE INVENTION

### Definitions

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a method, apparatus and computer program product for video compression. In this regard, the technology includes features wherein video content is initially obtained and subsequently separated into picture content and audio content. The picture content is separated into a frame by frame configuration, and a frame type for compression is determined for each of these frames. A frame is filtered and segmented into two or more portions, wherein each portion is indicative of a desired quantization for use during the encoding process. Each portion of the frame is subsequently encoded according to the respective desired quantization. Encoded picture content is subsequently generated and includes each encoded portion of a frame and its respective desired quantization. This encoded picture content is finally interleaved with the encoded audio content, thereby resulting in the compression of the video content. A reversal of this sequence of tasks will enable the substantial recreation of the video content from the interleaved encoded picture content and encoded audio content for potential subsequent presentation.

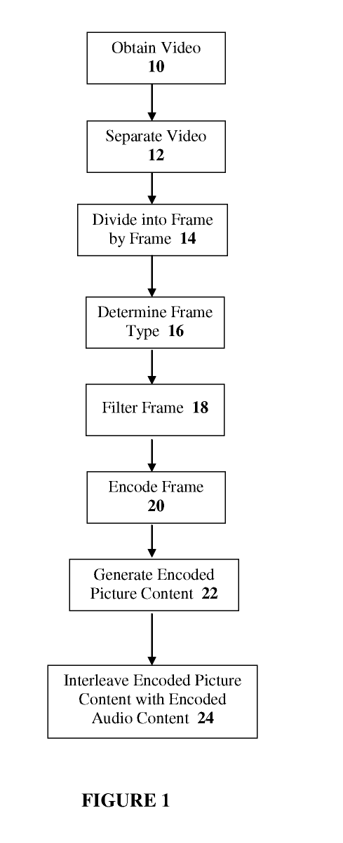

A method for encoding video in accordance with embodiments of the present invention is illustrated in FIG. 1. This method includes obtaining the video 10, and subsequently separating the video 12 into a picture portion and an audio portion. The picture portion is subsequently divided into a frame by frame format 14, and for each frame a frame type for compression 16 is determined Each of the frames is subsequently filtered 18 and then encoded 20. These frames are subsequently integrated into the encoded picture content 22. The encoded picture content and encoded audio content are subsequently interleaved 24, thereby forming the compressed video. This compressed video can be subsequently streamed or stored for later streaming

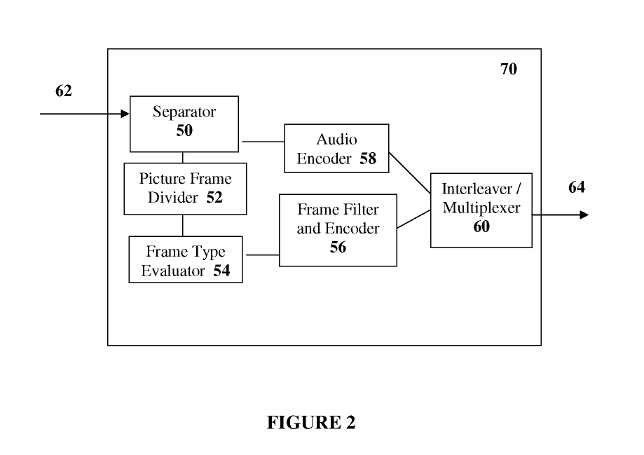

The above method can be performed by an apparatus for encoding video, wherein FIG. 2 illustrates an embodiment of such an apparatus. As illustrated the apparatus 70 includes a separator 50, which received the video content 62, wherein the separator is connected to components that encode picture content and the audio content. The audio is encoded by an audio encoder 58, and the picture content is encoded by a combination of a picture frame divider 52, frame type evaluator 54 and a frame filter and encoder 56. The interleaver/multiplexer 60 then interleaves the encoded audio with the encoded video, for subsequent streaming or storage 64.

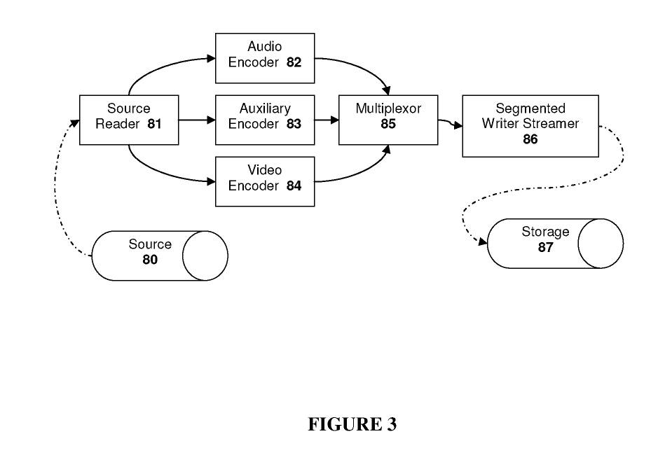

A general framework of an encoder in accordance with embodiments of the present invention is outlined in FIG. 3. In this figure the source 80 of the video is read by a source reader 81 (which could be a capture card driver, local file or streaming source) that also separates the signal to video, audio and auxiliary streams. The signal/frames are pushed to the output ‘pins’ and the subsequent objects are informed via a callback. The subsequent objects, the audio encoder 82 and video encoder 84 process the frames based on the desired compression settings and push the compressed result to their output ‘pins’ and in turn notify the child objects via a callback function to the multiplexor 85. The multiplexor will order the audio and video frames into the output stream based on the required decode order and tag the file container for storage 87 or stream with necessary meta-data.

According to some embodiments, the apparatus uses a progressive live stream protocol, wherein the encoder will chunk the live stream into discrete self-contained video segments based on the desired segment duration. In some embodiments, random group of pictures (GOP) lengths with an attempt to hit natural scene changes can be used. However, since the segment is self-contained the segment will not always be the exact desired duration.

According to some embodiments, the apparatus uses a live streaming protocol, wherein the encoder is essentially encoding the received live stream as it is received.

The components of the method and apparatus for video compression according to embodiments of the present invention are presented below.

### Obtaining Video Content

The method and apparatus of the present invention can be used for the compression of video content captured or obtained from a plurality of different sources. For example, the video content can obtained by or collected from captured satellite video signals, collected Internet transmission of video signals, DVD content, video storage devices, direct or indirect capturing of camera captured video content, and the like.

In some embodiments, the obtained video content can be in an uncompressed format, or can be in a known compressed format. In some embodiment, should the video content already be in an encoded format, transcoding this obtained video content into the compressed format according to the present invention can be performed.

### Separating Video Content

The method and apparatus of the present invention subsequently separates the obtained video content into picture content and audio content. In some embodiments, the obtained video content is separated into picture content, audio content and auxiliary content, wherein the auxiliary content comprises secondary audio tracks, captioned data, metadata and the like.

According to some embodiments, the separation of the picture portion of the video from the audio portion thereof is enabled by the source driver framework.

Other frameworks/mechanisms/methods for the separation of the picture portion of the video from the audio portion would be readily understood by a worker skilled in the art. In some embodiments, a framework may be DirectFB, gstreamer, DirectShow or the like.

Dividing Picture Content into Frame by Frame Configuration/Determining Frame Type for Compression

Upon the separation of the video content into picture content and audio content, the picture content is subsequently separated into a frame by frame configuration, thereby enabling the evaluation and encoding of each of the frames in order for the compression of this portion of the video content.

According to embodiments, the frame by frame configuration is analysed in order to determine if a frame is to be considered as an intra frame or an inter frame. An intra frame is essentially a stand-alone frame as it does not inherit any statistics or require any information from prior or sequent frames, whereas an inter frame references frames in the stream for the evaluation of the contents of the frame.

### Intra Frame Detection

According to embodiments, prior to compressing a frame, frame statistics can be analyzed to determine if the frame should be a inter or intra (key) frame; inter being a frame that references zero or more neighbouring frames, as it is possible that an inter frame may not reference any neighbouring frames. In some embodiments, inserting an intra frame, as it does not inherit any statistics or require any information from prior or sequent frames, allows for seeking and also provides a resynchronization point if there are any non-recoverable stream errors during the decode process. Given that an intra-frame will be larger in size than an inter-frame the encode engine must choose the best location to insert an intra-frame. The determination in calculating the frame type is referred to as a ‘scene-change detection’ though in practical terms it essentially refers to a frame that has “enough” changes that it would predominately be coded as intra regions/blocks; however another part of this decision process is based on the number of frames that have been processed since the last key frame.

In the case that an intra-frame is inserted during the middle of a natural scene, which happens quite frequently in low motion content such as a talk shows, evening news or video conferencing, one typically may notice a pulsing effect as the new decoded/reconstructed key frame will sometimes have quite a different error characteristic that the reconstructed frame from the prior GOP. This pulsing effect can be more visible on highly quantized video streams and can be predominantly noticeable in the ‘static’ background. In high motion content inserting a key frame mid natural scene may result in similar pulsing but can significantly increase the overall bandwidth/storage requirements. Thus it is important to not only detect natural scene changes, limit the number of key frames to a reasonable level and not have regular placement. The later criteria, namely irregular placement as it can be important for perceived reduction of this pulsing as fixed intervals for key frames on low motion content results in pulses at regular intervals and as patterns are quickly recognized one typically anticipate and ‘see’ pulses. An example of this irregular placement is programmatically described below in the pseudo code defined by “int IsFrameIntra”.

According to embodiments, a requirement to join or seek within a stream was such that there would be no more than a 2 second delay, which put an upper bound on the size of the GOP. In some instances as this was to be used in a real-time encoder, an additional requirement can be that the encoder was capable of encoding a set size of frames in real-time such that a frame could take an arbitrary length to encode as long as the set of frames were all encoded and transmitted within real-time. In some embodiments, this scenario was configured for use in a multi-core processor environment, selection of the following maximum GOP lengths was made, so that on average the sum of 5 subsequent GOPs would be a maximum 360 frames (or the encoder would need to take less than 12 seconds if the content is 30 FPS). In some embodiments, the GOP length was desired to be somewhat random, accordingly near prime numbers were selected. According to embodiments of the present invention, the following example can be used to obtain the outlined prerequisites:

ziRandomSizes[10]={57, 86, 69, 77, 36, 60, 70, 46, 40, 59}

In some embodiments, intra-frames need to be inserted based on GOP length and frame changes so in some embodiments, a histogram difference with a declining threshold based on the maximum GOP length and current GOP length was used. Example pseudo code which can be used to essentially achieve this desired functionality is defined below.

int IsFrameIntra(PUCHAR pImage, int nPixels, iMinLength) {

int m_ziRandomSizes[10] = { 57, 86, 69, 77, 36, 60, 70, 46, 40, 59 };
double dJFrameSensitivity = 2.5;
int l_diff, l_sum, i;
double d_avg, d_wei;
int k, sad;
m_sinceLastIntra++;
memset(m_currHistogram, 0, sizeof(m_currHistogram));
for (k=0; k < YFrameSize; k++)

m_currHistogram[pImage[k]]++;

l_diff=0;
for (k=0; k<256; k++) {

l_diff= l_diff+ abs(m_preHistogram[k]−m_currHistogram[k]);
m_preHistogram[k] = m_currHistogram[k];

}
if(m_sinceLastIntra == −1) {

return I_FRAME;

}
m_histogramDiffs[m_sinceLastIntra] = l_diff;
if(m_sinceLastIntra <2 ∥ (m_sinceLastIntra − m_numOfLastJFrame − 1)<2)

return P_FRAME;

if(m_sinceLastIntra < iMinLength) {

// wait till we get at least the minimum number of I frames
// must check the histogram difference
l_sum = 0;
for(i = m_numOfLastJFrame; i < m_sinceLastIntra − 1; i++) {

l_sum += m_histogramDiffs[i];

}
d_avg = (double) l_sum / (m_sinceLastIntra − m_numOfLastJFrame − 1.);
d_wei = 0;
if(l_diff > d_avg * (dJFrameSensitivity−d_wei)) {

m_numOfLastJFrame = m_sinceLastIntra−1;
return J_FRAME;

} else {

return P_FRAME;

}

}
else if(m_sinceLastIntra == m_ziRandomSizes[m_iCurrentSize]) {

// at max number of I frames, force return to I frame
m_sinceLastIntra = −1;
m_numOfLastJFrame = 0;
m_histCurr = l_diff;
m_iCurrentSize++;
if(m_iCurrentSize >= 10) {

m_iCurrentSize = 0;

}
return I_FRAME;

} else {

// must check the histogram difference
l_sum = 0;
for(i = 0; i < m_sinceLastIntra − 1 ; i++) {

l_sum += m_histogramDiffs[i];

}
d_avg = (double) l_sum / (m_sinceLastIntra − 1.);
d_wei = 3.2;
if(l_diff > d_avg * d_wei) {

m_sinceLastIntra = −1;
m_numOfLastJFrame = 0;
m_iCurrentSize++;
if(m_iCurrentSize >= 10) {

m_iCurrentSize = 0;

}
return I_FRAME;

}
else {

// wait till we get at least the minimum number of I frames
// must check the histogram difference
l_sum = 0;
for(i = m_numOfLastJFrame; i < m_sinceLastIntra − 1; i++) {

l_sum += m_histogramDiffs[i];

}
d_avg = (double) l_sum / (m_sinceLastIntra − m_numOfLastJFrame − 1.);
d_wei = 0;
if(l_diff > d_avg * (dJFrameSensitivity−d_wei)) {

m_numOfLastJFrame = m_sinceLastIntra−1;
return J_FRAME;

} else {

return P_FRAME;

}

}

}

}

### Intra Frame Determination

According to embodiments of the present invention, once it has been determined if the frame is an intra (I/J) or inter (P/B/mpB) frame, the evaluation of what sub-type should used for compression is determined. In the case of an I or J frame, the determination is quite simple as the J frame is an additional ‘recovery’ point that is not a randomly accessible point (seekable), however the intra frame is simple flagged as a J frame if the GOP is not yet long enough to justify an additional seek point. Inter frame determination is a little more complex; P frames are predicted from previous P or I frames whereas B frames are bidirectional and can be ‘predicted’ from prior or future frames. Inter frames can also have intra regions in which case the region is predicted from within the frame and does not have any temporal reference, namely a prior frame or future frame. Traditionally B frames cannot be used as a reference frame; however a pyramidal B frame is a B frame that can be used by subsequent B frames for prediction. There are benefits in using a pyramidal B frame, whereby you are loosening the restrictions of a B frame in that B frames are predictable therefrom. However the bitrate savings, upon compression, comes at a cost in that not only is the decoding order more complex, it also makes each B frame sequence quite ‘sensitive’ to stream errors. For example, one cannot selectively skip decoding a single B frame but would have to skip over an entire B frame sequence if there was stream corruption on a B frame, which is used for prediction of a subsequent B frame.

In some embodiments a multi-pyramidal B frame configuration wherein rather than having one ‘index’ or node in a sequence of B frames there are multiple indexes or reference frames. This configuration can allow for longer sequences of B frames without having the traditional performance with large sequences of B frames. Unlike traditional video codecs, each B frame may also have regions that are either intra and/or inter-coded; where the inter-coded regions may be predicted from either P or prior B frames.

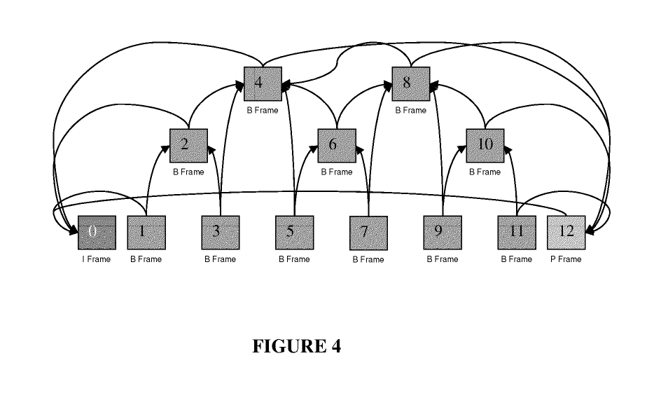

FIG. 4 illustrates a first configuration of a set of multiple pyramidal B frames is defined, wherein this configuration follows a binary tree structure. As illustrated in FIG. 4 this configuration of multiple pyramids is configured with 1 reference frame in each direction. In this embodiment, the decode order of the frames would be: 0, 12, 4, 2, 1, 3, 8, 6, 5, 7, 10, 9, 11.

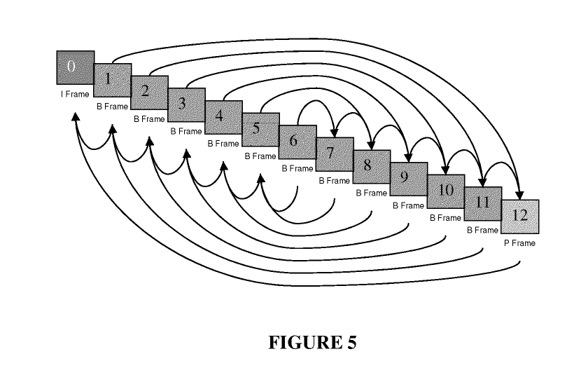

FIG. 5 illustrates a first configuration of a set of multiple pyramidal B frames is defined, wherein this configuration follows a linear structure. This linear structure has several benefits over the above noted binary tree structure, namely it is more predictable and uses slightly less processing power for the encoding and decoding process. However, the binary tree structure can provide a better degree of compression when compared to the linear structure. In this embodiment, the decode order of the frames would be: 0, 12, 1, 11, 2, 10, 3, 9, 4, 8, 5, 7, 6.

According to embodiments of the present invention, in the decode order of linear structure one can see how this linear method affords rendering at a quicker and constant delay. During the first half of the linear structure decode, decoding can occur at 2× the rendering speed O(n). However in the binary tree method, the rendering speed can be defined by O(n log n) where n is the height of the tree. In the example of binary tree structure, the tree only was 3 levels, so decoding was to occur at approximately 4× the rendering speed ((3*2) log (3*2)). In some embodiments, a way to get around this issue for both methods is to use a fixed window of pre-decoded frames, where the window is the maximum size of B frame sequences, so that substantially all future frames need only to be decoded at the source captured frame rate.

### Multiple Reference Frames

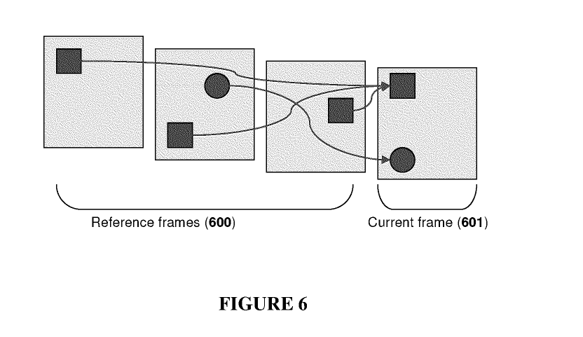

In some embodiments, in addition, to the frame types and their associated prediction modes the codec can also use multiple reference frames and use either direct or blended predictions. FIG. 6 outlines the effect of using multiple reference frames for coding regions of a frame, wherein in this example there are 3 reference frames 600, which are used to construct the current frame 601.

According to embodiments, a challenging part in using multiple reference frames is that again there is a corresponding almost linear growth in the processing requirement on the encode side. There is also a computing increase on the decoder side but this is substantially marginal; both sides have a growth on memory to store the decoded reference frames in memory. For example, by adding B frames which are bidirectional (3×2=6 reference frames) with the concept of multi-pyramidal B frames becomes rather complex and not only leads to possible latency but also resource consumption, for example processing power.

### Filtering Frames

The technology further comprises filtering one or more frames, wherein the filtering enables the segmentation of the frame into two or more portions, such that each portion is indicative of a desired quantization for the encoding of that portion of the frame.

In some embodiments, the filtering of the frame data will enable the substantially automatic identification of “portions” of the frame that may require more or less bits to enable an adequate level of compression which enables the desired level of picture quality upon decompression.

In some embodiments of the present invention, region based encoding is performed in order to identify the two or more portions of the frame for their associated desire level of quantization.

In some embodiments region based coding is configured to provide a real-time object segmentation of an arbitrary video stream. In some embodiments, this segmentation is performed by combining region detection with the traditional motion compensation component and enhancement layer proposals as a means to offload or reduce computational computer power required for the encoding process.

In some embodiments, object segmentation can be accomplished by many means comparison within the frame including color, texture, edge and motion. Object segmentation is useful for defining coherent motion vectors and varied levels of compression within the frame, for example regions of interest. In some embodiment, when object segmentation is of an abstract nature, the object could be defined as clusters of pixels that have similar characteristics which in turn aids in quantization and entropy coding.

### Background Detection

In some embodiments, background detection is performed in order to identify background portions within a particular frame. A primary reason to perform background detection is to identify an area where the bits can be redirected to a main component. For example for a 16×16 matrix of pixels on the original image, not transformed into the frequency domain or motion compensated, variance of the region can be determined whereby if the variance was less than a certain threshold, for example 25, then the region was flagged as the background. The background, or flat regions such as gradients, smoke or clouds, will typically not require many bits but generally result in nasty artifacts as the slight pixel fluctuations fall below the quantization level and do not get ‘represented’ until the error grows over time until the value falls within the quantization range. This results in flicking and/or flickering in flat areas. This does marginally increase the bitrate (2-5%) in the flat areas compared to before but will allow for overall lower bitrates as the flat areas will not have noticeable artifacts.

According to embodiments, pseudo Code for use for this background detection with a block based codec is presented below.

//for each 16x16 region in the original frame data
foreach(row_in_region) {
foreach(column_in_region) {

sum+=pixel(i,j); squared += pixel(i,j)*pixel(i,j);

}

}
variance = (squared − ((sum * sum)>>8) >>8)
if(variance<25)

regionmap(i,j).boostquality(variance)

### Additional Segmentation

According to embodiments, region based coding is extended to look at identifying similar components for example textures and colours. A desired goal for this further segmentation was not only to distribute the bitrate to areas of the image that may be more sensitive to artifacts but also to cluster pixels with similar characteristics to aid in compressibility with a context based arithmetic encoder.

According to embodiments, to improve the visual effect of the background detection, it may be desirable to remove any single groups that were not included. Example pseudo code for this aspect is defined below.

//for each 16x16 region in the regionmap (calculated earlier)
foreach(row_in_regionmap) {

foreach(column_in_regionmap) {

foreach(neighbour)

sum+=if(neighbour.isbackground( ));

}
tempmap(i,j) = (sum < 2? 0 : sum >7 ? 1 :
regionmap(i,j).isbackground( ))

}

}
foreach(row_in_tempmap) {

foreach(column_in_tempmap) {

foreach(neighbour)

sum+=if(neighbour.isbackground( ));

}
regionmap(i,j) = (sum < 1 ? 0 : sum >7 ? 1 :
tempmap(i,j).isbackground( ))

}

}

According to embodiments, the affect of the above pseudo code allowed for excluded regions that where potentially in a component or region that needs to have its quality improved could be included if there were enough neighbouring components that had the quality improved.

According to embodiments, there is a trade-off between compression efficiency and processing requirements. For example, the coding configuration can be designed such that the region based coding typically does not effect the decoding requirements whether there is one or a hundred different regions. However for each object or feature extraction algorithm employed during the encoding process results in a corresponding load increase, namely an increase in the required computational power to perform the encoding.

### Encoding Each Portion of Frame

The technology further comprises the encoding of each portion of the frame, wherein each portion is encoded based on a respective desired quantization. The encoding of the portion of the frame can be enabled by a plurality of encoding methods, for example, wavelet, entropy, quadtree encoding techniques and/or the like.

In some embodiments, the encoding of the portion of the frame can be enabled by a plurality of methods, wavelet, DCT/hadamard, quadtree, coupled with some sort of entropy encoding techniques such as variable length codes or arithmetic coding.

In some embodiments, arithmetic coding, which provides the mathematically optimal entropy encoding, usually has two methods. A first method of encoding is termed the priori method and is based on probabilities are ‘learned’ and hard coded based on a standard or generalized coding data set, and uses a static probability distribution and usually is how variable length codes are coded. The second method is called posteriori method where the coding tables or data sets are generated and adapted during the encoding process. This is called an adaptive arithmetic coding. In this second method the assumption is that at the start of the encoding process everything has equal possibilities (or random) and the tables are modified during the processing. In some embodiments this adaptive process can be improved by providing priori skewed distributions, further referred to as semi-adaptive arithmetic coding.

In some embodiments, the encoding process can include a semi-adaptive arithmetic coding process wherein the coding tables or data sets can be segregated into different tables per frame type. The tables themselves provide a probability distribution for certain events, values, signals to occur based on a context. Looking at the values that are to be coded it can be quite different in an I frame verses a P frame or B frame. While, P and B frames were quite similar, generally the P frame had higher coefficients and more coefficients than the lower entropy B frames. As such, P and B frames had unique tables.

In some embodiments, this encoding process can be further improved by allowing the tables to stay ‘alive’ for the duration of the GOP. The GOP usually defines a ‘scene’ which means that there is substantially no need to change or reset the arithmetic tables for each frame that we encode; regardless of whether the frame is a P or B frame.

In some embodiments, the downside of having a GOP length duration live span for an adaptive arithmetic table is that if there is any sort of data or stream corruption the remainder of the GOP is non-decodable for that frame type. This means that if the error happens on a B frame, the remainder of the B frames of that GOP cannot be decoded. And likewise if the error happens on a P frame, both the P frames and B frames cannot be decoded for the remainder of the GOP. In some embodiments when there is little to no error correction in the stream, even non-adaptive arithmetic tables were used, things would not substantially change as the remainder of the GOP in the non-adaptive configuration would not be decodable without introducing visual artifacts.

In some embodiments, one can interpret the quantized region as a bitplane fashion instead of a literal value so that the coefficients are processed using hybrid bitplane coding, where one can combine traditional DCT and wavelet coefficient coding styles. For example, take a region and break it up into 4 quadrants, wherein each quadrant is evaluated for the particular bitplane to see if it has a significant coefficient. A significant quadrant is further processed until there is a block that is 4×4 or smaller. The four 2×2 child blocks are used to form the significance value pattern (SVP) of the currently processed bitplane. For each ‘significant’ 2×2 child block the actual value is encoded using the following algorithm If there is only one pixel that is significant (non-zero bit for that bitplane) then code the 4 bits using an entropy coding such as variable length code or arithmetic coding. If there are more than one significant bits then code the actual value for the 4 pixels one-by-one using an entropy coding method and subsequently these blocks are removed from the list of blocks to process. This later method of coding the values can be further improved by including context based on neighbouring SVPs as well the height from the most significant bit of the bitplane that is currently within the coding process. The above technique can be referred to as Hybrid Bit-Plane Coding.

### Preprocessing: Motion Compensated Temporal Denoising

According to embodiments, preprocessing is a step where the video signal is altered so that it is easier to encode. While looking at non-algorithmic ways to increase the visual quality and reduce the overall bitrates there are various preprocessing tools.

In some embodiments, a built-in temporal denoiser is integrated into the video encoder. For example, after identifying where the object moved to, a comparison of the current pixel with the previous frame is made. If the change is not above a certain threshold context based averaging based on neighbours and the pixel's previous value is performed. If the change between the current pixel and the neighbour is greater than a certain threshold it can be safely assumed that there is an edge, or real detail that shouldn't be removed. As the encoding engine already calculates where the block moved to, the ability to provide a motion compensated denoise process is substantially lightweight, for example in computing power requirements. For example, this denoise process can allow the core encoding engine to filter out low level noise which can be quantized away during the entropy coding phase. The temporal denoiser operates on a variable block/object size depending on how the core encoding engine decided to subdivide the frame into the various objects.

In some embodiments, when testing the motion compensated temporal denoising, it was determined that applying it to the chroma channels resulted in too much colour bleeding due to the lower spatial resolution of the colour channel in relation to the luma. Thus in some embodiments, the denoiser is only applied to the luma or brightness, with the added benefit that the CPU load is reduced.

In some embodiments, low level noise is added on the decoder side to improve the appearance of the decoded video stream, the default range being from +/−3, the encoder side would require that that the noise removed would be approximately that same amount that is barely perceivable. The neighbouring pixel values are examined to determine if the target center pixel's variance is a result of noise or a true desired “impulse” such as texture or an edge. According to some embodiments, the “certain threshold” was chosen to be: 7.

Pseudo code for the motion compensated temporal denoising is present below, in accordance with some embodiments of the present invention.

//done after motion compensation
scaledtab = {0, 32767, 16384, 10923, 8192, 6554, 5461, 4681, 4096,
3641, 3277, 2979, 2731, 2521, 2341, 2185};
foreach(column_of_region) {

foreach(row_of_region) {

if(diff(currPixel,prevPixel)!=0) then

foreach(surrounding_3x3_pixels)

if(diff(currPixel,neighbourPixel)<=7)

increaseCount++; sumValue+=neighbourPixel;

endif

value = (sumValue * 2 + increaseCount) *
scaledtab[increaseCount] >>16;
else
value = currPixel;
endif
regionArray[column][row] = value
}

}

According to some embodiments, the conditional factor can be modified to also include whether or not samples greater than the certain threshold could be an extreme noise sample. For example, this would require analyzing if the sample was isolated in order to determine if there was a true edge or if it was a ‘salt and pepper’ type noise. This modification can enable the removal of strong noise values that did not occur within the threshold and also protect strong edges without blurring.

### Generating Encoded Picture Content

The technology further comprises generating the encoded picture content which includes each encoded portion of the frame and its respective desired quantization. For example, the generation of the picture content portion of the bitstream is enabled such that the quantization used will be directly associated with each of the specific portions of the frame, in this manner providing an implicit indication to the decoder regarding how to decompress that portion of the bitstream to recreate that portion of the frame represented thereby.

According to embodiments, as noted above during region detection ‘flat’ regions were compared to regions with high texture. In the case of a flat region it is desired to ensure that the quantization of that region is quite a bit lower than the rest of the frame as although the flat areas will have relatively low entropy it will also be more sensitive to propagated errors as the slight signal at least in part representative of this region is likely to will be under the dead-zone. For example, if a DCT like transform is being used, the flat area will likely be most sensitive to errors in the DC coefficients. In some embodiments, an arbitrary adjustment is integrated into the encoding process to account for this sensitivity. However, for live video content with frequent GOPs, it is likely best to use an aggressive quality increase on the flat regions, for example to the extent of reducing the quantization index to ¼ for the DC components and ¾ for the AC components. Each region or block uses a ‘delta quantization’ indicator in the header, if the indicator states whether a different quantization was used for that group of pixels and whether if so the delta was weak, strong or custom. In this way the codec can provide regions with different qualities without expressly coding a quantization map.

Interleaving Encoded Picture Content with Encoded Audio Content

The technology further comprises the interleaving the encoded picture content with the audio content which has also been encoded. This interleaving provides a means for “synchronizing” the encoded picture with the encoded audio content for subsequent decompression for viewing if desired. This interleaving results in the creation of the compressed video content that can be subsequently stored or streamed to a desired location, or stored for future streaming.

According to embodiments of the present invention, by substantially reversing the encoding process the encoded video content can be decoded thereby enabling the presentation thereof to a viewer. As would be readily understood by a worker skilled in the art, the decoding process may be somewhat easier than the encoding process as some aspects of the decoding process may not have the same level of computation as it did during the encoding process. For example, in some embodiments, for a particular frame of encoded video content, the encoded video content would contain details relating to the type of frame to be decoded, as such, while the decoding still has to determine the type of frame for decoding, this is performed by reading the required data defining the frame type rather than scanning the uncompressed picture content to determine what type of frame should be used for the encoding process.

In some embodiments, another example of a modification of the method for the decoding of an encoded video content, is the denoising step of the encoding process. In the reciprocal decoding step, the decoder can be configured to renoise, or insert a desired level of noise into the decoded frame.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, PL/1, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for compressing video, said method comprising:
a) obtaining video content;
b) separating the video content into picture content and audio content;
c) dividing the picture content into a frame by frame configuration;
d) determining frame type for compression of one or more frames of the frame by frame configuration;
e) filtering one or more frames, said filtering enabling segmentation of the frame into two or more portions, each portion indicative of a desired quantization;
f) encoding each portion of the frame, wherein each portion is encoded based on a respective desired quantization;
g) generating encoded picture content which includes each encoded portion of the frame and its respective desired quantization; and
h) interleaving the encoded picture content with encoded audio content resulting in compression of the video content.

2. The method according to claim 1, wherein the frame-by frame configuration is separated into groups of pictures which define a collection of frames and wherein determining frame type includes determining if a frame is an intra frame or an inter frame.

3. The method according to claim 2, wherein determining if a frame is an intra frame is dependent on a length of the group of pictures or changes in a particular frame relative to a previous frame.

4. The method according to claim 3, wherein determining if a frame is an intra frame is based on a histogram difference with a declining threshold based on a maximum length of a group of pictures and a current length of a group of pictures.

5. The method according to claim 2, wherein an inter frame is configured as a multi-pyramidal B frame, wherein the intra frame is constructed based on multiple indexes or reference frames.

6. The method according to claim 1, wherein filtering one or more frames is performed using region based coding, which provides object segmentation within a frame.

7. The method according to claim 6, wherein object segmentation is performed by comparisons based on one or more of colour, texture, edge and motion.

8. The method according to claim 6, wherein filtering one or more frames includes background detection in order to identify background portions within a particular frame.

9. The method according to claim 7, wherein the region based coding identifies one or more regions of a frame having similar characteristics relating to texture or colour or both.

10. The method according to claim 1, wherein encoding each portion of the frame is performed using arithmetic coding, wherein arithmetic coding is configured to provide a substantially mathematically optimal entropy encoding.

11. The method according to claim 10, wherein the arithmetic coding is based on a priori method which is based on a coding data set that is standard or generalized.

12. The method according to claim 10, wherein the arithmetic coding is based on a posterior method which is based on coding data sets which are generated and adapted during encoding.

13. The method according to claim 10, wherein arithmetic coding is based on a semi-adaptive process wherein coding data sets are segregated into different sets based on frame type.

14. The method according to claim 1, wherein encoding each portion of the frame is performed using hybrid bitplane coding, which is a combination of a DCT coding and wavelet coding.

15. The method according to claim 1, wherein prior to encoding each portion of the frame, motion compensated temporal denoising is performed.

16. The method according to claim 15, wherein motion compensated temporal denoising is based on luma.

17. A computer program product comprising code which, when loaded into memory and executed on a processor of a computing device, is adapted to compress video content, the code adapted to perform:
a) obtaining video content;
b) separating the video content into picture content and audio content;
c) dividing the picture content into a frame by frame configuration;
d) determining frame type for compression of one or more frames of the frame by frame configuration;
e) filtering one or more frames, said filtering enabling segmentation of the frame into two or more portions, each portion indicative of a desired quantization;
f) encoding each portion of the frame, wherein each portion is encoded based on a respective desired quantization;
g) generating encoded picture content which includes each encoded portion of the frame and its respective desired quantization; and
h) interleaving the encoded picture content with encoded audio content resulting in compression of the video content.

18. An apparatus for compressing video, said apparatus comprising:
a) a separator configured to obtain video content and separate the video content into picture content and audio content;
b) a picture frame divider configure to divide the picture content into a frame by frame configuration;
c) a frame type evaluator configured to determine frame type for compression of one or more frames of the frame by frame configuration;
d) a frame filter and encoder configured to filter one or more frames, said filtering enabling segmentation of the frame into two or more portions, each portion indicative of a desired quantization, the frame filter and encoder further configured to encode each portion of the frame, wherein each portion is encoded based on a respective desired quantization and generate encoded picture content which includes each encoded portion of the frame and its respective desired quantization;
e) an audio encoder configured to encode the audio content; and
f) an interleaver/multiplexer configured to interleave the encoded picture content with encoded audio content resulting in compression of the video content.

19. The apparatus according to claim 18, wherein the frame-by frame configuration is separated into groups of pictures which define a collection of frames and wherein the frame type evaluator is further configured to determine if a frame is an intra frame or an inter frame.

20. The apparatus according to claim 19, wherein determining if a frame is an intra frame is dependent on a length of the group of pictures or changes in a particular frame relative to a previous frame.

21. The apparatus according to claim 20, wherein determining if a frame is an intra frame is based on a histogram difference with a declining threshold based on a maximum length of a group of pictures and a current length of a group of pictures.

22. The apparatus according to claim 19, wherein an inter frame is configured as a multi-pyramidal B frame, wherein the intra frame is constructed based on multiple indexes or reference frames.

23. The apparatus according to claim 18, wherein the frame filter and encoder is configured to filter one or more frames using region based coding, which provides object segmentation within a frame.

24. The apparatus according to claim 23, wherein object segmentation is performed by comparisons based on one or more of colour, texture, edge and motion.

25. The apparatus according to claim 23, wherein the frame filter and encoder is configured to one or more frames using background detection in order to identify background portions within a particular frame.

26. The apparatus according to claim 24, wherein the region based coding identifies one or more regions of a frame having similar characteristics relating to texture or colour or both.

27. The apparatus according to claim 18, wherein the frame filter and encoder is configured to encode each portion of the frame is performed using arithmetic coding, wherein arithmetic coding is configured to provide a substantially mathematically optimal entropy encoding.

28. The apparatus according to claim 27, wherein the arithmetic coding is based on a priori method which is based on a coding data set that is standard or generalized.

29. The apparatus according to claim 27, wherein the arithmetic coding is based on a posterior method which is based on coding data sets which are generated and adapted during encoding.

30. The apparatus according to claim 27, wherein arithmetic coding is based on a semi-adaptive process wherein coding data sets are segregated into different sets based on frame type.

31. The apparatus according to claim 18, wherein the frame filter and encoder is configured encode each portion of the frame is performed using hybrid bitplane coding, which is a combination of a DCT coding and wavelet coding.

32. The apparatus according to claim 18, wherein prior to encoding each portion of the frame, the frame filter and encoder is configured to perform motion compensated temporal denoising.

33. The apparatus according to claim 32, wherein motion compensated temporal denoising is based on luma.
